(19) United States
(12) Patent Application Publication
(10) Pub. No.: US 2026/0233795 A1
(43) Pub. Date: Aug. 13, 2026

(54) MOBILE BODY

(71) Applicant: SONY GROUP CORPORATION, TOKYO (JP)

(72) Inventor: KAZUO HONGO, TOKYO (JP)

(21) Appl. No.: 19/161,278

(22) PCT Filed: Jan. 29, 2024
(86) PCT No.: PCT/JP2024/002602

§ 371 Date: Sep. 1, 2025

(30) Foreign Application Priority Data
Mar. 24, 2023 (JP) 2023-047896

(51) Int. Cl. B62D 57/028; B60B 19/00

(52) U.S. Cl. CPC B62D 57/028; B60B 19/003

(57) ABSTRACT

To provide a mobile body that can perform both omnidirectional wheel traveling and leg walking. A mobile body including: a main body part; at least two or more omnidirectional wheels attached to the main body part and rotated by driving of a motor; and a leg part that extends, contracts, and revolves on the basis of a rotation angle change of a first shaft interlocking with rotation of each of the omnidirectional wheels and a rotation angle change of a second shaft coaxial with the first shaft.

### TECHNICAL FIELD

The present disclosure relates to a mobile body.

### BACKGROUND ART

In recent years, a legged mobile body that can freely walk and move on an uneven surface such as stairs or an unpaved road by a plurality of leg parts has been developed. The legged mobile body can select a point where the leg is to be grounded in a distributed manner, and thus, can smoothly move on an uneven ground where there is a ground crack, a step, or the like.

On the other hand, there is also a wheeled mobile body that can perform wheel traveling by a plurality of wheels driven by a motor or the like. The wheeled mobile body can travel at high speed on a flat leveled ground with a relatively simple mechanism.

Therefore, a mobile body that exhibits high moving ability in both the uneven ground and the leveled ground by using a leg mechanism and a wheel mechanism in combination has been studied (see Patent Document 1 below).

### CITATION LIST

Patent Document 1: Japanese Patent Application Laid-Open No. 2006-315587

### SUMMARY OF THE INVENTION

### Problems to be Solved by the Invention

However, it is difficult for the mobile body disclosed in Patent Document 1 described above to perform omnidirectional wheel traveling.

Therefore, the present disclosure proposes a new and improved mobile body that can perform both omnidirectional wheel traveling and leg walking.

### Solutions to Problems

According to the present disclosure, there is provided a mobile body including: a main body part; at least two or more omnidirectional wheels attached to the main body part and rotated by driving of a motor; and a leg part that extends, contracts, and revolves on the basis of a rotation angle change of a first shaft interlocking with rotation of each of the omnidirectional wheels and a rotation angle change of a second shaft coaxial with the first shaft.

### BRIEF DESCRIPTION OF DRAWINGS

FIG. 1 is a perspective view illustrating a structure of a mobile body according to a first structure.

FIG. 2 is a perspective view illustrating a state at the time of wheel traveling of the mobile body illustrated in FIG. 1.

FIG. 3 is a perspective view illustrating a state at the time of leg walking of the mobile body illustrated in FIG. 1.

FIG. 4 is a schematic view illustrating a schematic structure of a mobile body according to a second structure.

FIG. 5 is a modification in which an attachment angle between an omnidirectional wheel and a leg part is adjusted by using a universal joint.

FIG. 6 is a modification in which the leg part is formed elastically deformable in a left-right direction.

FIG. 7 is a schematic plan view illustrating a first detailed structure of the mobile body illustrated in FIG. 4.

FIG. 8 is a schematic plan view illustrating a second detailed structure of the mobile body illustrated in FIG. 4.

FIG. 9 is a schematic plan view illustrating a first detailed structure of the mobile body illustrated in FIG. 5.

FIG. 10 is a schematic plan view illustrating a second detailed structure of the mobile body illustrated in FIG. 5.

FIG. 11 is an explanatory diagram illustrating a structure of a leg part and an extension/contraction mechanism according to a first modification.

FIG. 12 is an explanatory diagram illustrating a structure of a leg part and an extension/contraction mechanism according to a second modification.

FIG. 13 is an explanatory diagram illustrating a structure of a leg part and an extension/contraction mechanism according to a third modification.

FIG. 14 is an explanatory diagram illustrating a structure of a leg part and an extension/contraction mechanism according to a third modification.

FIG. 15 is an explanatory diagram illustrating a structure of a leg part and an extension/contraction mechanism according to a fourth modification.

FIG. 16 is an explanatory diagram illustrating a structure of a leg part and an extension/contraction mechanism according to a fifth modification.

FIG. 17 is an explanatory view for explaining control of a leg part according to a sixth modification.

FIG. 18 is an explanatory view for explaining control of a leg part according to a seventh modification.

FIG. 19 is an explanatory view for explaining control of a leg part according to an eighth modification.

FIG. 20 is a schematic plan view illustrating a schematic structure of a mobile body including omnidirectional wheels and leg parts in all four wheels.

FIG. 21 is a schematic plan view illustrating a schematic structure of a mobile body including omnidirectional wheels in all four wheels and leg parts in only two front wheels.

FIG. 22 is a schematic plan view illustrating a schematic structure of a mobile body including omnidirectional wheels and leg parts in two front wheels.

### MODE FOR CARRYING OUT THE INVENTION

A preferred embodiment of the present disclosure will be described below in detail, with reference to the accompanying drawings. Note that, in the present description and drawings, components having substantially the same functional configuration are denoted by the same reference signs, and redundant description is omitted.

Note that the description will be given in the following order.
1. Structure of mobile body
1.1. First structure
1.1. Second structure
1.2.2. Outline
1.2.2. Details
2. Modifications of leg part
2.2. Modification regarding structure
2.2. Modification regarding control
3. Supplementary note

### 1. Structure of Mobile Body

### 1.1. First Structure

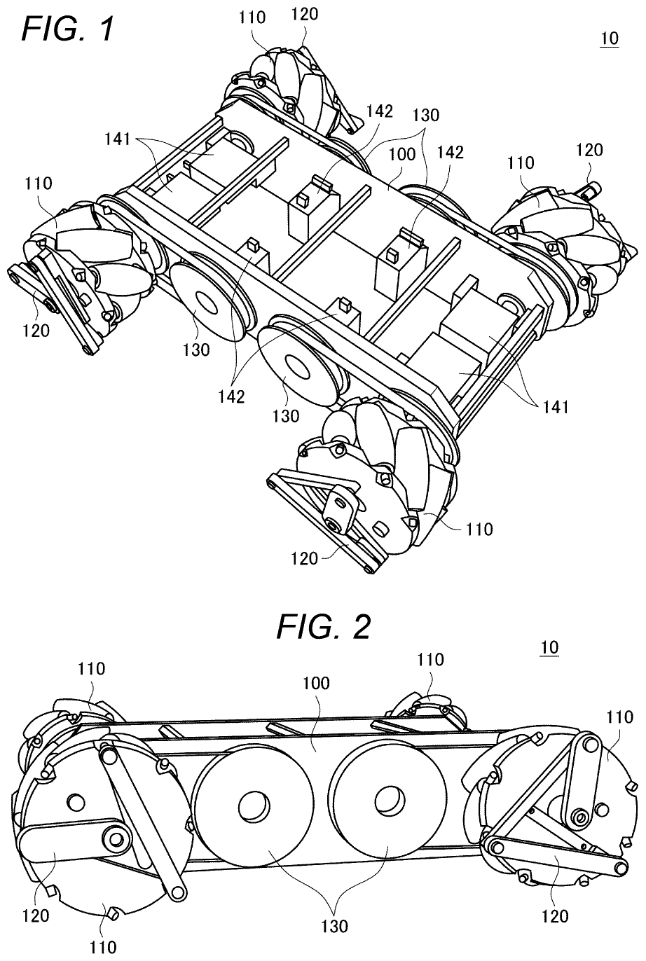

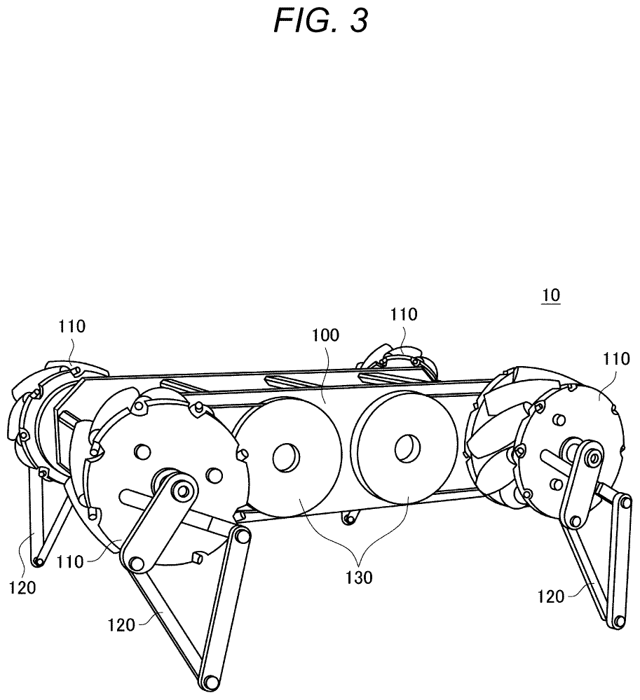

First, a first structure of a mobile body according to a first embodiment of the present disclosure will be described with reference to FIGS. 1 to 3. FIG. 1 is a perspective view illustrating a structure of a mobile body 10 according to a first structure. FIG. 2 is a perspective view illustrating a state at the time of wheel traveling of the mobile body 10 illustrated in FIG. 1. FIG. 3 is a perspective view illustrating a state at the time of leg walking of the mobile body 10 illustrated in FIG. 1.

As illustrated in FIG. 1, the mobile body 10 according to the first structure includes one main body part 100 and four omnidirectional wheels 110. The four omnidirectional wheels 110 are each provided with a leg part 120, a first motor 141, a second motor 142, and a transmission mechanism 130. Hereinafter, an example in which the mobile body 10 includes four omnidirectional wheels 110 will be mainly described. However, the mobile body 10 may include two omnidirectional wheels 110, six omnidirectional wheels 110, or eight omnidirectional wheels 110.

The main body part 100 has a housing of a rectangular parallelepiped shape and corresponds to a body part of the mobile body 10. The four omnidirectional wheels 110 and the four transmission mechanisms 130 are each provided on the side surface of the housing of the main body part 100. In the housing of the main body part 100, four first motors 141 are each provided correspondingly to each of the four omnidirectional wheels 110, and second motors 142 are each provided correspondingly to each of the four transmission mechanisms 130. Furthermore, although not illustrated, a control device that controls the overall motion of the mobile body 10 and a power supply device that supplies power to each part of the mobile body 10 are further provided inside the housing of the main body part 100.

The omnidirectional wheel 110 is a wheel that can translate omnidirectionally. The omnidirectional wheels 110 are each provided in each of the four locations of the housing of the main body part 100. Specifically, the omnidirectional wheel 110 may be a wheel in which a plurality of barrel-shaped rollers is arranged on a traveling surface of the wheel in the circumferential direction. The omnidirectional wheel 110 can cause the mobile body 10 to translate omnidirectionally by the main rotation of the entire wheel by the first motor 141 and the driven rotation of each of the barrel-shaped rollers arranged on the traveling surface.

For example, the omnidirectional wheel 110 may be a mecanum wheel. The mecanum wheel is a wheel in which a plurality of barrel-shaped rollers extending in an oblique direction with respect to the circumferential direction of the wheel is attached side by side on the traveling surface in the circumferential direction. In a case where the omnidirectional wheel 110 is a mecanum wheel, the mobile body 10 can translate omnidirectionally and turning on the spot by controlling the rotation speed and the rotation direction of the omnidirectional wheel 110 provided in each of the four locations of the housing of the main body part 100.

The first motor 141 is an electric motor that rotates the omnidirectional wheel 110. The first motor 141 is provided inside the housing of the main body part 100 correspondingly to each of the four omnidirectional wheels 110. The first motor 141 can independently rotate each of the four omnidirectional wheels 110.

The leg part 120 includes a closed-loop link mechanism and is provided on the side of the omnidirectional wheel 110. Specifically, the leg part 120 may include a closed-loop four-node link mechanism having two drive shafts, that is, a first shaft connected to the rotation shaft of the omnidirectional wheel 110 and a second shaft coaxial with the first shaft. Such a four-node link mechanism can extend and contract by a rotation angle difference between the first shaft and the second shaft.

With this arrangement, the leg part 120 including the four-node link mechanism can extend and contract by the rotation angle difference between the first shaft interlocked with the rotation of the omnidirectional wheel 110 by the first motor 141 and the second shaft driven by the second motor 142. Therefore, the leg part 120 can extend, contract, and revolve on the basis of the rotation angle change of the first shaft by the first motor 141 and the rotation angle change of the second shaft by the second motor 142.

The second motor 142 is an electric motor that rotates the second shaft of the leg part 120 via the transmission mechanism 130. The second motor 142 is provided inside the housing of the main body part 100 correspondingly to each of the four leg parts 120. The second motor 142 can independently rotate each of the second shafts of the four leg parts 120 via the transmission mechanism 130.

The transmission mechanism 130 is a driving force transmission mechanism that transmits the rotational force of the second motor 142 to the second shaft of the leg part 120. The transmission mechanism 130 is provided on the side of the housing of the main body part 100 correspondingly to each of the four leg parts 120. For example, the transmission mechanism 130 may include a first pulley connected to the rotation shaft of the second motor 142, a second pulley connected to the second shaft of the leg part 120, and a belt bridged between the first pulley and the second pulley. The transmission mechanism 130 can rotate the second shaft of the leg part 120 by transmitting the rotation of the second motor 142 to the second pulley by the first pulley and the belt.

With this arrangement, as illustrated in FIG. 2, the mobile body 10 can perform wheel traveling by the omnidirectional wheels 110 by rotating the first motor 141 and the second motor 142 at the same rotation speed while maintaining the rotation angle difference between the first shaft and the second shaft in which the leg part 120 is in the contracted state. Furthermore, as illustrated in FIG. 3, the mobile body 10 can perform leg walking by the leg parts 120 by revolving the first motor 141 and the second motor 142 while maintaining the rotation angle difference between the first shaft and the second shaft in which the leg part 120 is in the extended state.

Therefore, according to the above configuration, because the mobile body 10 can perform omnidirectional wheel traveling by the omnidirectional wheels 110 and leg walking by the leg parts 120, the movement adapted to both an uneven ground and a ground can be performed.

### 1.1. Second Structure

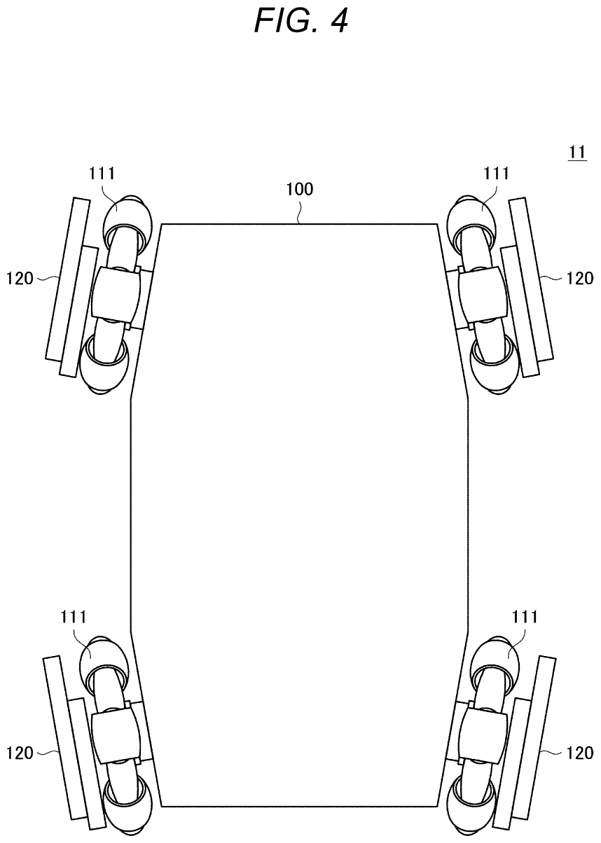

Next, a second structure of the mobile body according to the present embodiment will be described with reference to FIGS. 4 to 10.

### 1.2.2. Outline

An outline of a mobile body 11 according to the second structure will be described with reference to FIG. 4. FIG. 4 is a schematic plan view illustrating a schematic structure of the mobile body 11 according to the second structure. In FIG. 4, the first motor 141, the second motor 142, and the transmission mechanism 130 are not illustrated.

As illustrated in FIG. 4, the mobile body 11 according to the second structure is different from the mobile body 10 illustrated in FIG. 1 in that the omnidirectional wheel 111 is an omni wheel. The omni wheel is a wheel in which a plurality of barrel-shaped rollers extending in a circumferential direction of the wheel is attached side by side on the traveling surface in the circumferential direction.

In general, in a case where the mobile body 11 is to be translated omnidirectionally by using the omni wheels, each of the omni wheels is attached to the main body part 100 such that rotation directions of the wheels are orthogonal to each other. However, in such a case, in the mobile body 11, because the revolving directions of the respective leg parts 120 provided on the sides of the omnidirectional wheels 111 are also orthogonal to each other, leg walking by the leg parts 120 becomes difficult.

On the other hand, in a case where the omnidirectional wheels 111 are attached to the main body part 100 such that the rotation directions of the omnidirectional wheels 111 are parallel to each other, in the omni wheel of the omnidirectional wheel 111, the orientations of the barrel-shaped rollers provided on the traveling surface of the wheel in the circumferential direction are parallel to each other. In such a case, because the mobile body 11 cannot apply force in the rotation shaft direction of the omnidirectional wheel 111, the movement in the rotation shaft direction by the rotation of the omnidirectional wheel 111 becomes difficult to be controlled.

In the mobile body 11 illustrated in FIG. 4, the omnidirectional wheel 111 is attached to the main body part 100 in an inclined manner at an angle of more than 0 degrees and less than 45 degrees, preferably at an angle of 10 degrees or more and 30 degrees or less with respect to the traveling direction of the mobile body 11. In such a case, because the mobile body 11 can align the revolving direction of the leg part 120 approximately parallel to the traveling direction of the mobile body 11, leg walking by the leg part 120 can be executed. Furthermore, in the mobile body 11, because the omnidirectional wheels 111 that are omni wheels can be attached to the main body part 100 in a state of being inclined with respect to each other, force in the left-right direction orthogonal to the traveling direction of the mobile body 11 can be applied. Therefore, the mobile body 11 can translate in the left-right direction orthogonal to the traveling direction of the mobile body 11 by the rotation of the omnidirectional wheels 111.

With this arrangement, for example, the mobile body 11 can pass through a narrow place where it is difficult to turn, by left-right movement without turning. Furthermore, in a case where an object or the like is being transported by an arm separately provided on the mobile body 11, the mobile body 11 can move left and right without greatly swinging the arm by turning. With this arrangement, because the mobile body 11 does not cause a change in the center of gravity due to swinging of the arm at the time of moving left and right orthogonal to the traveling direction, the object can be safely transported without losing balance.

Moreover, the omnidirectional wheel 111 that is the omni wheel can change distribution of speed and torque between the traveling direction of the mobile body 11 and the left-right direction orthogonal to the traveling direction by an attachment angle to the main body part 100. For example, the mobile body 11 illustrated in FIG. 4 can perform wheel traveling with high torque and low speed in the traveling direction and can perform wheel traveling with low torque and high speed in the left-right direction.

Here, in the mobile body 11 illustrated in FIG. 4, the leg part 120 is revolved in an inclined manner with respect to the traveling direction of the mobile body 11. Therefore, because the mobile body 11 walks while swinging the main body part 100 left and right along the revolving direction of the leg part 120 at the time of leg walking, an internal force is generated inside the mobile body 11 at the time of kicking the ground, which may cause damage or the like.

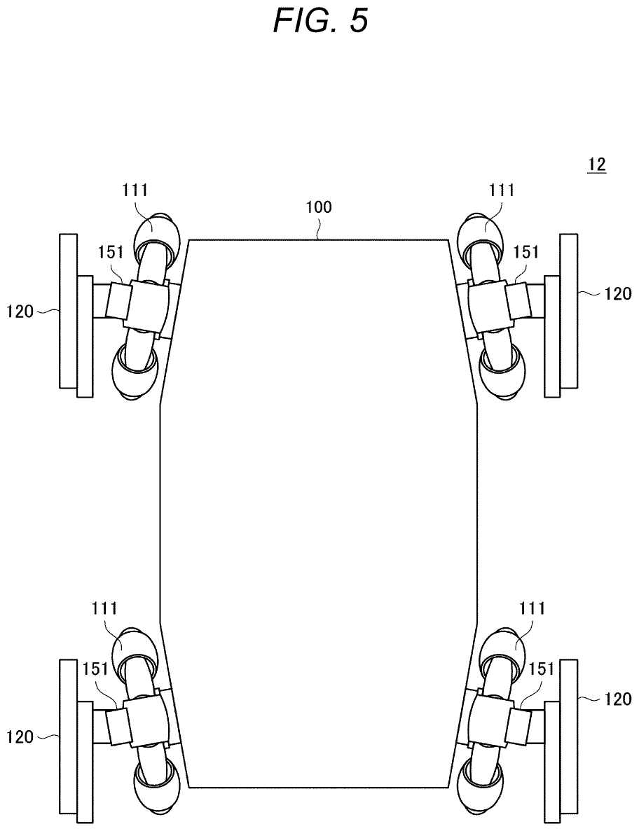

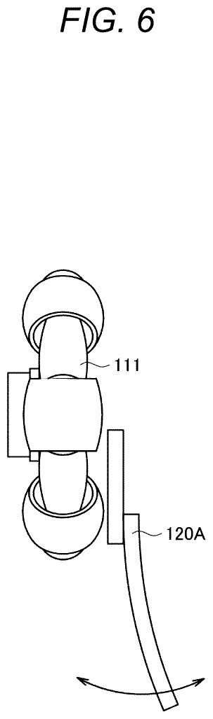

Hereinafter, a modification for eliminating or alleviating the influence of internal force on the leg part 120 and the like in a case where the omnidirectional wheel 111 is attached to the main body part 100 in an inclined manner will be described with reference to FIGS. 5 and 6. FIG. 5 is a modification in which an attachment angle between the omnidirectional wheel 111 and the leg part 120 is adjusted by using a universal joint 151. FIG. 6 is a modification in which the leg part 120 is formed elastically deformable in the left-right direction.

In the modification illustrated in FIG. 5, the mobile body 12 can control the orientations of the omnidirectional wheel 111 and the leg part 120 independently of each other by connecting the omnidirectional wheel 111 and the leg part 120 by the universal joint 151.

The universal joint 151 is a mechanism that can transmit rotation between the rotation shaft of the omnidirectional wheel 111 and the first shaft of the leg part 120, and connects the rotation shaft of the omnidirectional wheel 111 and the first shaft of the leg part 120 at a free angle. The universal joint 151 can transmit the rotation of the omnidirectional wheel 111 to the first shaft of the leg part 120 even if the first shaft of the leg part 120 is not coaxial with the rotation shaft of the omnidirectional wheel 111. With this arrangement, because the mobile body 12 can independently control the orientation of the omnidirectional wheel 111 and the orientation of the leg part 120, the orientation of the leg part 120 can be made parallel to the traveling direction of the mobile body 12. Therefore, because the mobile body 12 can prevent the main body part 100 from swinging left and right at the time of leg walking, an internal force can be prevented from being generated inside the mobile body 12 when the leg part kicks the ground.

In the modification illustrated in FIG. 6, a leg part 120A may be formed elastically deformable in the left-right direction orthogonal to the traveling direction of the mobile body 11. Specifically, the leg part 120A may be provided by a member or a structure that is elastically deformable in the left-right direction orthogonal to the traveling direction of the mobile body 11. With this arrangement, the leg part 120A can absorb the internal force by the elastic deformation of the leg part 120A, the internal force being generated in the left-right direction generated at the time when the leg part is grounded while the main body part 100 is swung left and right. Therefore, the mobile body 11 can reduce the load applied to the entire structure by the internal force in the left-right direction received by the leg part 120A at the time of grounding. Moreover, because the leg part 120A can reduce the swinging of the main body part 100 in the left-right direction by bending the distal end at the time of grounding, collision, falling, or the like of the mobile body 11 can be suppressed.

### 1.2.2. Details

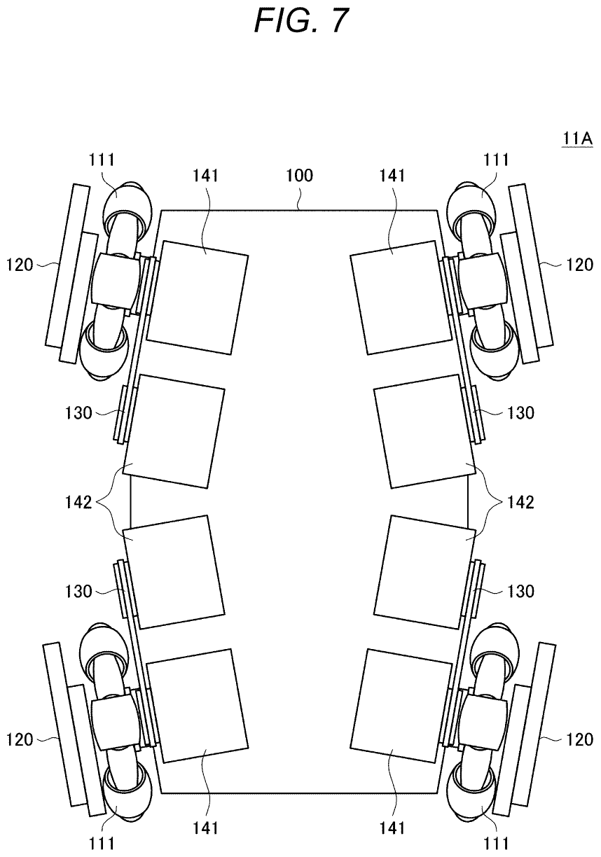

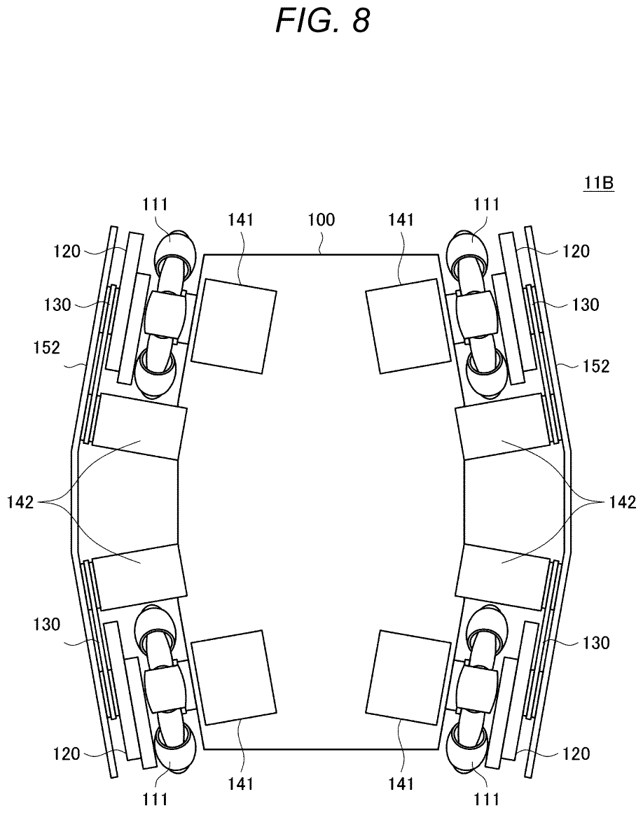

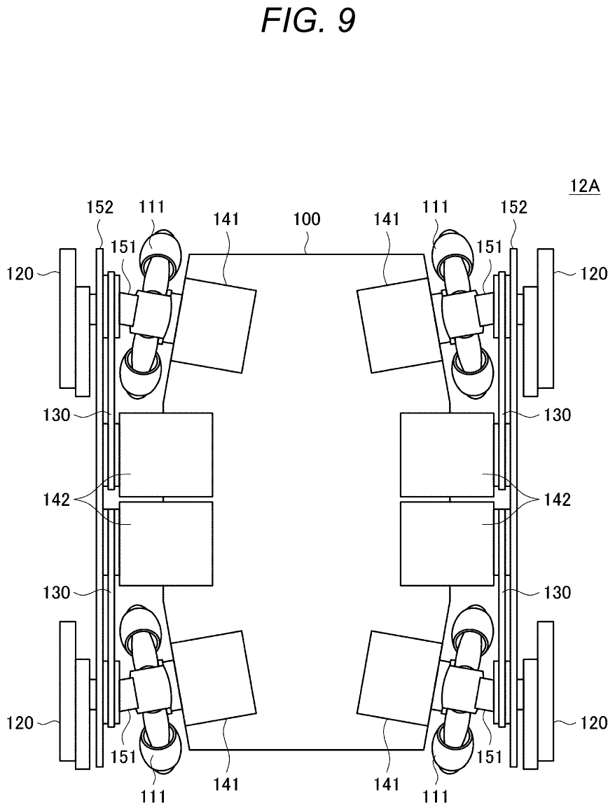

Next, detailed structures of the mobile body 11 illustrated in FIG. 4 will be described with reference to FIGS. 7 and 8. FIG. 7 is a schematic plan view illustrating a first detailed structure of the mobile body 11 illustrated in FIG. 4. FIG. 8 is a schematic plan view illustrating a second detailed structure of the mobile body 11 illustrated in FIG. 4. FIGS. 7 and 8 each illustrate a structure in which the first motor 141, the second motor 142, and the transmission mechanism 130 are added to the structure illustrated in FIG. 4.

As illustrated in FIG. 7, a mobile body 11A according to the first detailed structure includes one main body part 100 and four omnidirectional wheels 111. The four omnidirectional wheels 111 are each provided with the leg part 120, the first motor 141, the second motor 142, and the transmission mechanism 130.

The omnidirectional wheel 111 is an omni wheel, and is attached to the main body part 100 in an inclined manner at an angle of 10 degrees or more and 30 degrees or less with respect to the traveling direction of the mobile body 11A. The leg part 120 includes a closed-loop link mechanism and is provided on the side of the omnidirectional wheel 111. The leg part 120 can extend and contract by the rotation angle difference between the first shaft connected to the rotation shaft of the omnidirectional wheel 111 and the second shaft coaxial with the first shaft.

The first motor 141 is provided inside the housing of the main body part 100 correspondingly to each of the omnidirectional wheels 111, and rotates the omnidirectional wheel 111. The second motor 142 is provided inside the housing of the main body part 100 correspondingly to each of the leg parts 120, and rotates the second shaft of the leg part 120 via the transmission mechanism 130. The transmission mechanism 130 is provided between the main body part 100 and the omnidirectional wheel 111, and transmits the rotational force of the second motor 142 to the second shaft of the leg part 120. The transmission mechanism 130 may include, for example, a pair of pulleys across which a belt is stretched.

As illustrated in FIG. 8, a mobile body 11B according to the second detailed structure includes one main body part 100 and four omnidirectional wheels 111. The four omnidirectional wheels 111 are each provided with the leg part 120, the first motor 141, the second motor 142, and the transmission mechanism 130. Moreover, the mobile body 11B is provided with exterior parts 152 on both sides in the left-right direction of the main body part 100.

The omnidirectional wheel 111 is an omni wheel, and is attached to the main body part 100 in an inclined manner at an angle of 10 degrees or more and 30 degrees or less with respect to the traveling direction of the mobile body 11B. The leg part 120 includes a closed-loop link mechanism and is provided on the side of the omnidirectional wheel 111. The leg part 120 can extend and contract by the rotation angle difference between the first shaft connected to the rotation shaft of the omnidirectional wheel 111 and the second shaft coaxial with the first shaft.

The first motor 141 is provided inside the housing of the main body part 100 correspondingly to each of the omnidirectional wheels 111, and rotates the omnidirectional wheel 111. The second motor 142 is provided in a protruding manner from the housing of the main body part 100 correspondingly to each of the leg parts 120, and rotates the second shaft of the leg part 120 via the transmission mechanism 130. The transmission mechanism 130 is provided on the outer side of the leg part 120, and transmits the rotational force of the second motor 142 to the second shaft of the leg part 120 from the outer side. The transmission mechanism 130 may include, for example, a pair of pulleys across which a belt is stretched.

The exterior part 152 is provided further outer side of the transmission mechanism 130 to cause the entire side surface of the mobile body 11B to be covered. By the exterior part 152 sandwiching the pair of pulleys of the transmission mechanism 130 with the leg part 120 and the second motor 142 from both sides, the transmission mechanism 130 can be prevented from being damaged at the time when the rotational force is transmitted.

Note that, in applications such as transportation of an object, it is desirable to employ the structure of the mobile body 11B illustrated in FIG. 8 rather than the structure of the mobile body 11A illustrated in FIG. 7. This is because the mobile body 11B illustrated in FIG. 8 can transport more objects because the free space in the central portion of the main body part 100 can be made larger than that of the mobile body 11A illustrated in FIG. 7.

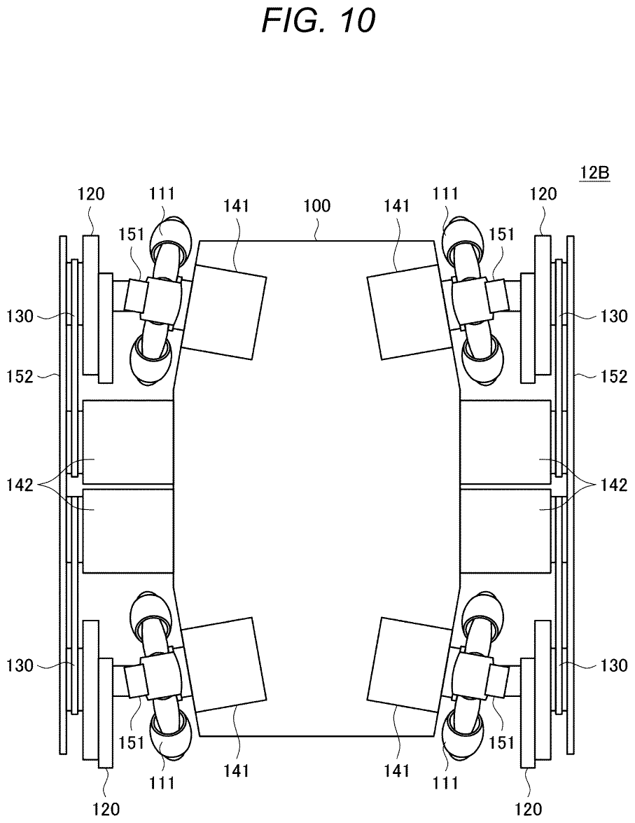

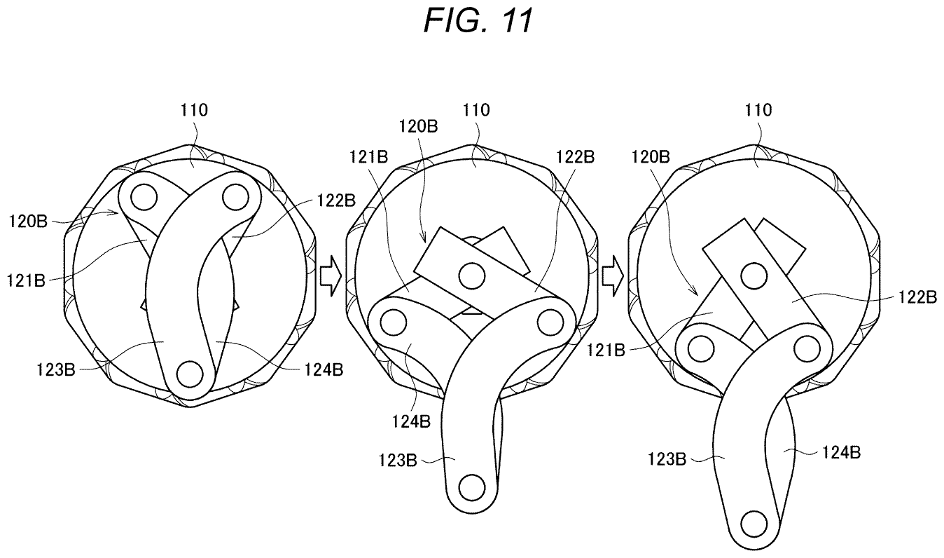

Next, detailed structures of the mobile body 12 illustrated in FIG. 5 will be described with reference to FIGS. 9 and 10. FIG. 9 is a schematic plan view illustrating a first detailed structure of the mobile body 12 illustrated in FIG. 5. FIG. 10 is a schematic plan view illustrating a second detailed structure of the mobile body 12 illustrated in FIG. 5. FIGS. 9 and 10 each illustrate a structure in which the first motor 141, the second motor 142, and the transmission mechanism 130 are added to the structure illustrated in FIG. 5.

As illustrated in FIG. 9, a mobile body 12A according to the first detailed structure includes one main body part 100 and four omnidirectional wheels 111. The four omnidirectional wheels 111 are each provided with the leg part 120, the universal joint 151, the first motor 141, the second motor 142, and the transmission mechanism 130.

The omnidirectional wheel 111 is an omni wheel, and is attached to the main body part 100 in an inclined manner at an angle of 10 degrees or more and 30 degrees or less with respect to the traveling direction of the mobile body 12A. The leg part 120 includes a closed-loop link mechanism and is provided on the side of the omnidirectional wheel 111 while interposing the universal joint 151. The leg part 120 can extend and contract by the rotation angle difference between the first shaft connected to the rotation shaft of the omnidirectional wheel 111 via the universal joint 151 and the second shaft coaxial with the first shaft.

The universal joint 151 is provided between the omnidirectional wheel 111 and the leg part 120. The universal joint 151 can transmit rotation between the rotation shaft of the omnidirectional wheel 111 and the first shaft of the leg part 120, and connects the rotation shaft of the omnidirectional wheel 111 and the first shaft of the leg part 120 at a free angle.

The first motor 141 is provided inside the housing of the main body part 100 correspondingly to each of the omnidirectional wheels 111, and rotates the omnidirectional wheel 111. The second motor 142 is provided in a protruding manner from the housing of the main body part 100 correspondingly to each of the leg parts 120, and rotates the second shaft of the leg part 120 via the transmission mechanism 130. The transmission mechanism 130 is provided between the leg part 120 and the universal joint 151, and transmits the rotational force of the second motor 142 to the second shaft of the leg part 120. The transmission mechanism 130 may include, for example, a pair of pulleys across which a belt is stretched.

The exterior part 152 is provided between the leg part 120 and the transmission mechanism 130 in a manner that the entire side surface of the mobile body 12A is covered. By the exterior part 152 sandwiching the pair of pulleys of the transmission mechanism 130 with the universal joint 151 and the second motor 142 from both sides, the transmission mechanism 130 can be prevented from being damaged at the time when the rotational force is transmitted.

As illustrated in FIG. 10, a mobile body 12B according to the second detailed structure includes one main body part 100 and four omnidirectional wheels 111. The four omnidirectional wheels 111 are each provided with the leg part 120, the universal joint 151, the first motor 141, the second motor 142, and the transmission mechanism 130. Moreover, the mobile body 12B is provided with exterior parts 152 on both sides in the left-right direction of the main body part 100.

The omnidirectional wheel 111 is an omni wheel, and is attached to the main body part 100 in an inclined manner at an angle of 10 degrees or more and 30 degrees or less with respect to the traveling direction of the mobile body 12B. The leg part 120 includes a closed-loop link mechanism and is provided on the side of the omnidirectional wheel 111 while interposing the universal joint 151. The leg part 120 can extend and contract by the rotation angle difference between the first shaft connected to the rotation shaft of the omnidirectional wheel 111 while interposing the universal joint 151 and the second shaft coaxial with the first shaft.

The universal joint 151 is provided between the omnidirectional wheel 111 and the leg part 120. The universal joint 151 can transmit rotation between the rotation shaft of the omnidirectional wheel 111 and the first shaft of the leg part 120, and connects the rotation shaft of the omnidirectional wheel 111 and the first shaft of the leg part 120 at a free angle.

The first motor 141 is provided inside the housing of the main body part 100 correspondingly to each of the omnidirectional wheels 111, and rotates the omnidirectional wheel 111. The second motor 142 is provided in a protruding manner from the housing of the main body part 100 correspondingly to each of the leg parts 120, and rotates the second shaft of the leg part 120 via the transmission mechanism 130. The transmission mechanism 130 is provided on the outer side of the leg part 120, and transmits the rotational force of the second motor 142 to the second shaft of the leg part 120 from the outer side. The transmission mechanism 130 may include, for example, a pair of pulleys across which a belt is stretched.

The exterior part 152 is provided further outer side of the transmission mechanism 130 to cause the entire side surface of the mobile body 12B to be covered. By the exterior part 152 sandwiching the pair of pulleys of the transmission mechanism 130 with the leg part 120 and the second motor 142 from both sides, the transmission mechanism 130 can be prevented from being damaged at the time when the rotational force is transmitted.

Note that, in applications such as transportation of an object, it is desirable to employ the structure of the mobile body 12B illustrated in FIG. 10 rather than the structure of the mobile body 12A illustrated in FIG. 9. This is because the mobile body 12B illustrated in FIG. 10 can transport more objects because the free space in the central portion of the main body part 100 can be made larger than that of the mobile body 12A illustrated in FIG. 9.

### 2. Modifications of Leg Part

### 2.2. Modification Regarding Structure

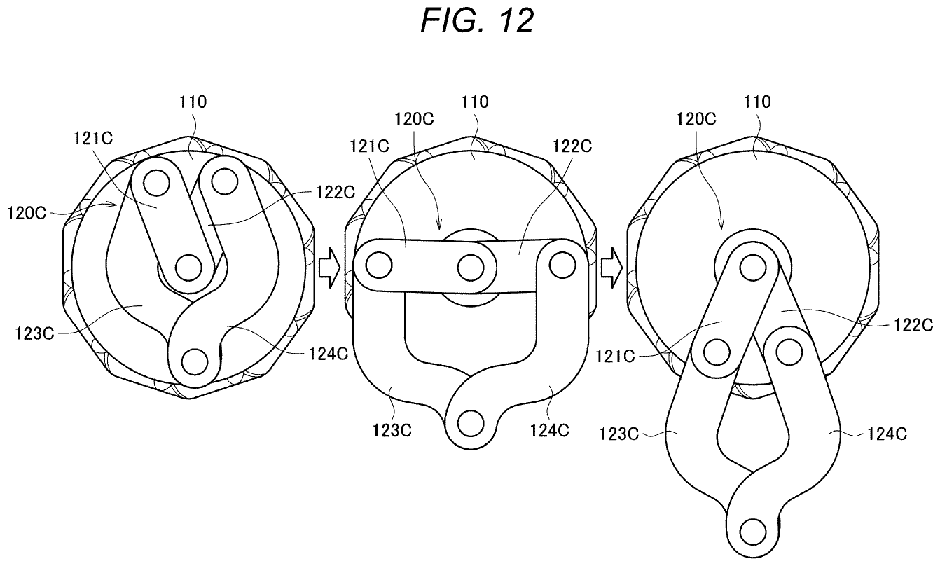

Next, first to fifth modifications relating to the structure of the leg part 120 will be described with reference to FIGS. 11 to 16.

### First Modification

FIG. 11 is an explanatory diagram illustrating a structure of a leg part 120B and an extension/contraction mechanism according to a first modification. As illustrated in FIG. 11, the leg part 120B includes a closed-loop four-node link in which a first link 121B, a second link 122B, a third link 123B, and a fourth link 124B are connected to each other. The leg part 120B can extend and contract the third link 123B and the fourth link 124B in a predetermined direction by controlling the rotation angle difference between the first link 121B and the second link 122B connected to the first shaft and the second shaft, respectively.

In the leg part 120B according to the first modification, the third link 123B and the fourth link 124B are provided in a shape curved toward the inner side of the closed loop of the four-node link. Specifically, the third link 123B and the fourth link 124B may be provided in an arc shape curved in a direction facing each other. In such a case, the leg part 120B can be configured such that a space formed between the third link 123B and the fourth link 124B becomes smaller or no space is formed therebetween at the time of extension and contraction of the four-node link.

With this arrangement, the leg part 120B can prevent foreign matters from being caught in the space formed between the third link 123B and the fourth link 124B at the time of extension and contraction of the four-node link. Therefore, the leg part 120B can prevent leg walking from being hindered due to catching of foreign matters, and meanwhile, can prevent damage to the object due to the object being caught by the third link 123B and the fourth link 124B.

### Second Modification

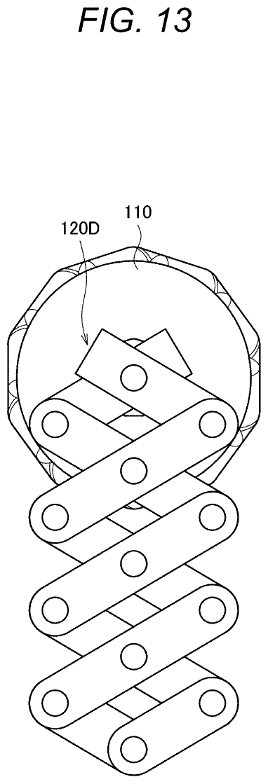

FIG. 12 is an explanatory diagram illustrating a structure of a leg part 120C and an extension/contraction mechanism according to a second modification. As illustrated in FIG. 12, the leg part 120C includes a closed-loop four-node link in which a first link 121C, a second link 122C, a third link 123C, and a fourth link 124C are connected to each other. The leg part 120C can extend and contract the third link 123C and the fourth link 124C in a predetermined direction by controlling the rotation angle difference between the first link 121C and the second link 122C connected to the first shaft and the second shaft, respectively.

In the leg part 120C according to the second modification, in order to reduce the axial thicknesses of the first shaft and the second shaft, each of the first link 121C, the second link 122C, the third link 123C, and the fourth link 124C is connected to other links on the same surface at both ends of the link. In particular, the third link 123C and the fourth link 124C are provided in a shape curved toward the outer side of the closed loop so as not to interfere with the first link 121C and the second link 122C at the time of extension and contraction of the four-node link.

Specifically, the first link 121C is connected to one of the first shaft and the second shaft and to the third link 123C on the back surface side with respect to the paper surface of FIG. 12. The second link 122C is connected to the other of the first shaft and the second shaft and to the fourth link 124C on the front surface side with respect to the paper surface of FIG. 12. The third link 123C is connected to the first link 121C and the fourth link 124C on the front surface side with respect to the paper surface of FIG. 12. The fourth link 124C is connected to the second link 122C and the third link 123C on the back surface side with respect to the paper surface of FIG. 12. In such a case, the leg part 120C can prevent three or more of the first link 121C, the second link 122C, the third link 123C, and the fourth link 124C from overlapping each other at the time when the four-node link extends and contracts.

With this arrangement, in the leg part 120C, because the axial thickness of the first shaft and the second shaft can be reduced, the leg part 120C can be further downsized.

### Third Modification

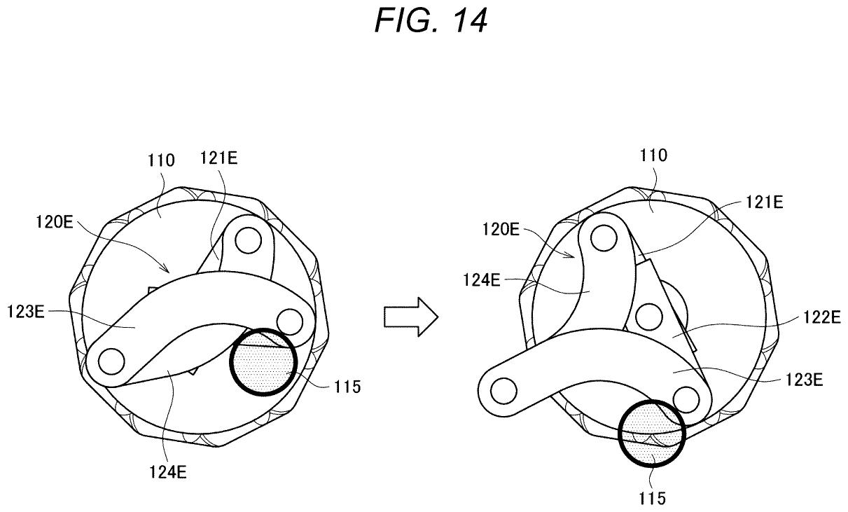

FIG. 13 is an explanatory diagram illustrating a structure of a leg part 120D and an extension/contraction mechanism according to a third modification. As illustrated in FIG. 13, the leg part 120D includes a link mechanism having a pantograph structure. The leg part 120D can extend and contract the link mechanism having a pantograph structure in a predetermined direction by controlling the rotation angle difference between the two links connected to the first shaft and the second shaft.

With this arrangement, the leg part 120D can contract so as to fall within the diameter of the omnidirectional wheel 110 at the time of wheel traveling, and can extend longer than 1.5 times the omnidirectional wheel 110 at the time of leg walking. Therefore, because the mobile body 10 can make a stride of the leg part 120D longer during leg walking, types of terrains that can be traversed by leg walking can be increased.

### Fourth Modification

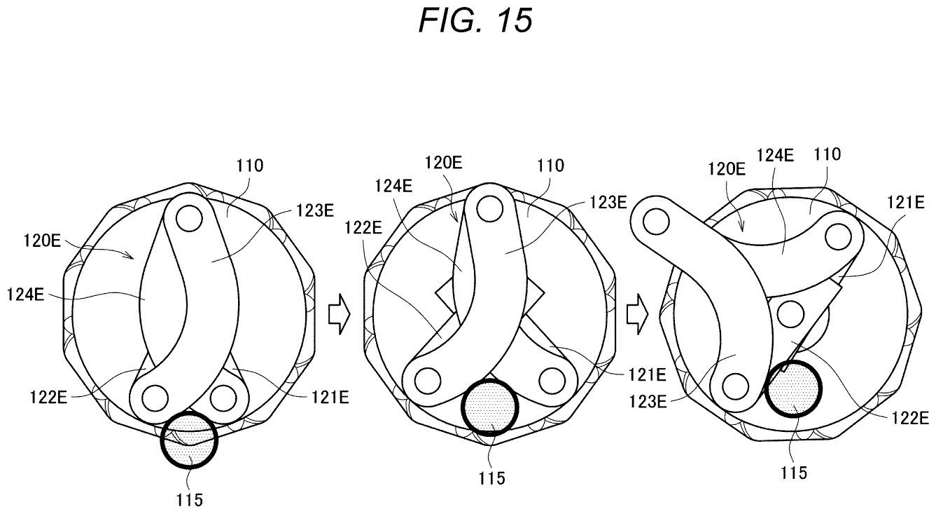

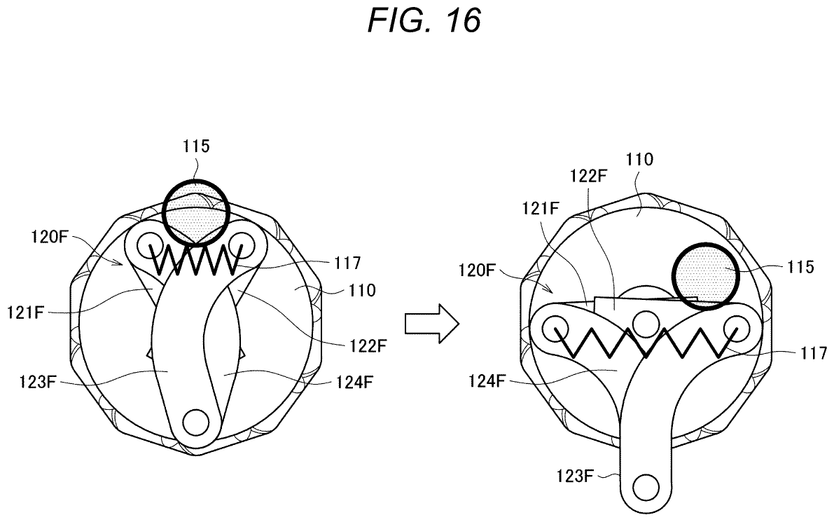

FIGS. 14 and 15 are explanatory diagrams illustrating a structure of a leg part 120E and an extension/contraction mechanism according to a fourth modification. As illustrated in FIGS. 14 and 15, the leg part 120E includes a closed-loop four-node link in which a first link 121E, a second link 122E, a third link 123E, and a fourth link 124E are connected to each other. The leg part 120E can extend and contract the third link 123E and the fourth link 124E in a predetermined direction by controlling the rotation angle difference between the first link 121E and the second link 122E connected to the first shaft and the second shaft, respectively.

In the leg part 120E according to the fourth modification, a caster 115 is further provided on any one link of the four-node link. The caster 115 is a wheel that can freely rotate on a rotation shaft parallel to the rotation shaft of the omnidirectional wheel 110. As illustrated in FIGS. 14 and 15, for example, the caster 115 may be provided on the inner side or outer side of an arc of the arc shape of the third link 123E. However, the caster 115 may be provided on any link as long as the caster is housed within the diameter of the omnidirectional wheel 110 in one extension/contraction state of the leg part 120E and protrudes from the diameter of the omnidirectional wheel 110 in another extension/contraction state of the leg part 120E.

In such a case, in the mobile body 10, the leg part 120E is extended and contracted to cause the caster 115 to protrude from the diameter of the omnidirectional wheel 110, so that the caster 115 can be grounded to perform wheel traveling. By fixing the states of the omnidirectional wheel 110 and the leg part 120E, the leg part 120E in which the caster 115 is grounded can stably perform wheel traveling by the caster 115 without having the first motor 141 and the second motor 142 driven.

With this arrangement, by driving the two front wheels or the two rear wheels of the mobile body 10 in the traveling direction in wheel traveling by the casters 115, the number of the first motors 141 and the second motors 142 to be driven can be reduced. Therefore, the mobile body 10 can perform wheel traveling with lower power consumption.

### Fifth Modification

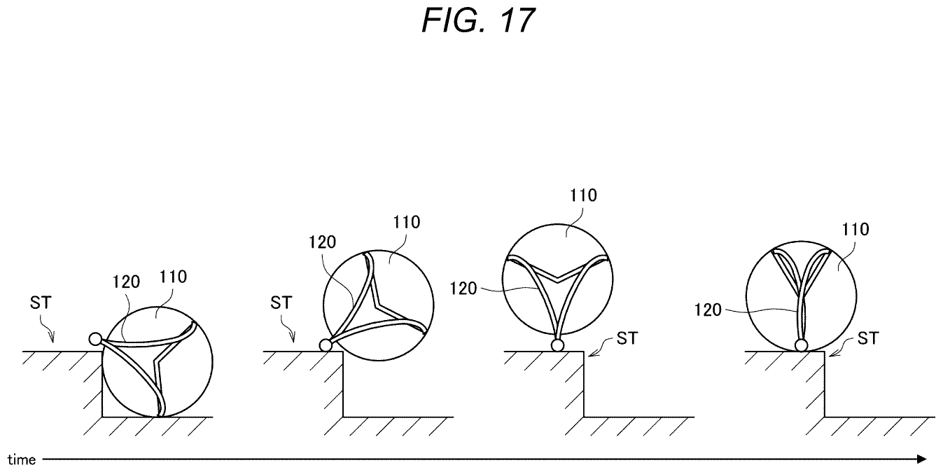

FIG. 16 is an explanatory diagram illustrating a structure of a leg part 120F and an extension/contraction mechanism according to a fifth modification. As illustrated in FIG. 16, the leg part 120F includes a closed-loop four-node link in which a first link 121F, a second link 122F, a third link 123F, and a fourth link 124F are connected to each other. The leg part 120F can extend and contract the third link 123F and the fourth link 124F in a predetermined direction by controlling the rotation angle difference between the first link 121F and the second link 122F connected to the first shaft and the second shaft, respectively.

In the leg part 120F according to the fifth modification, the caster 115 is further provided on the outer side of an arc of the arc shape of the third link 123F. Furthermore, a spring member 117 is further provided between the third link 123F and the fourth link 124F.

The caster 115 is a wheel that can freely rotate on a rotation shaft parallel to the rotation shaft of the omnidirectional wheel 110. The caster 115 is provided so as to protrude from the diameter of the omnidirectional wheel 110 at the time when the four-node link of the leg part 120F contracts. By grounding the caster 115 protruding from the diameter of the omnidirectional wheel 110, the leg part 120F can perform wheel traveling by the caster 115.

The spring member 117 is, for example, a tension spring that generates a tension between the third link 123F and the fourth link 124F. In a case where the wheel traveling using the caster 115 is performed, the spring member 117 can push back the force applied to the caster 115 from the ground by applying tensile tension to the third link 123F and the fourth link 124F. On the other hand, in a case where the leg part 120F is to be extended, by the spring member 117 applying the tensile tension to the third link 123F and the fourth link 124F after the third link 123F and the fourth link 124F are fully opened, the extension of the leg part 120F can be urged.

With this arrangement, because the mobile body 10 can push back the force applied to the caster 115 from the ground by the spring member 117, the posture of the leg part 120F that performs wheel traveling by the caster 115 can be further stabilized. Furthermore, because the extension of the four-node link can be urged by the spring member 117 at the time when the leg part 120F extends, the mobile body 10 can more quickly switch from the wheel traveling state to the leg walking state using the leg part 120F.

### 2.2. Modification Regarding Control

Subsequently sixth to eighth modifications related to the control of the leg part 120 are described with reference to FIGS. 17 to 19.

### Sixth Modification

FIG. 17 is an explanatory view for explaining control of the leg part 120 according to the sixth modification. As illustrated in FIG. 17, the mobile body 10 can climb a larger step ST by causing the leg part 120 protruding from the diameter of the omnidirectional wheel 110 to act on the step ST at the time of wheel traveling by the omnidirectional wheel 110.

In the normal wheel traveling, the mobile body 10 can only climb the step ST having a height of about ⅓ of the diameter of the wheel. In the sixth modification, the mobile body 10 can lift the omnidirectional wheel 110 up to the upper surface of the step ST by causing the distal end of the leg part 120 to protrude from the diameter of the omnidirectional wheel 110 and to be hooked on the upper surface of the step ST. Thereafter, the mobile body 10 can continue the wheel traveling by the omnidirectional wheel 110 on the upper surface of the step ST by accommodating the distal end of the leg part 120 within the diameter of the omnidirectional wheel 110.

With this arrangement, the mobile body 10 can also climb the step ST having a height of ½ of the diameter of the omnidirectional wheel 110 by further causing the leg part 120 to move at the time of wheel traveling by the omnidirectional wheel 110. Therefore, the mobile body 10 can further improve the step climbing ability.

### Seventh Modification

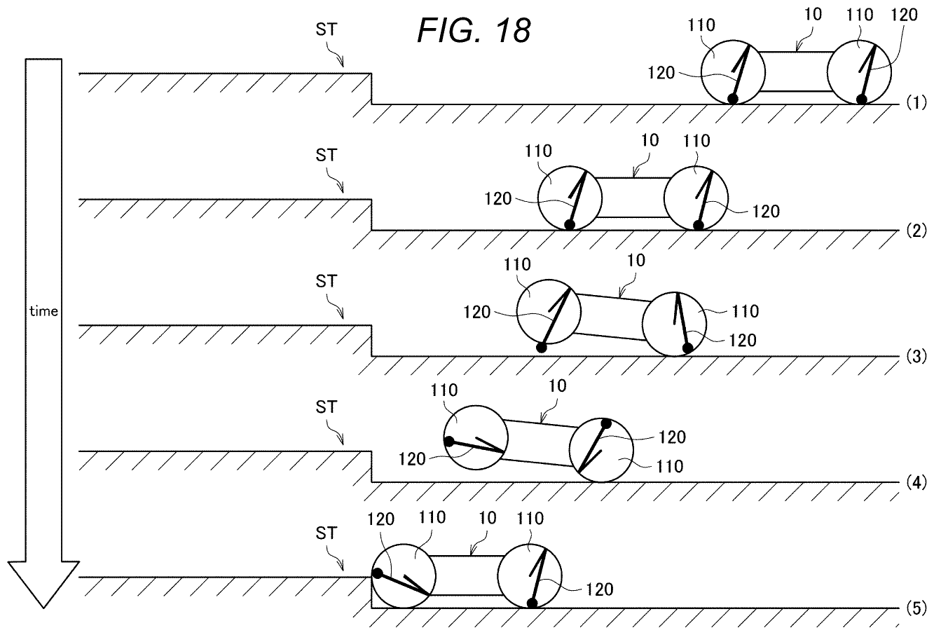

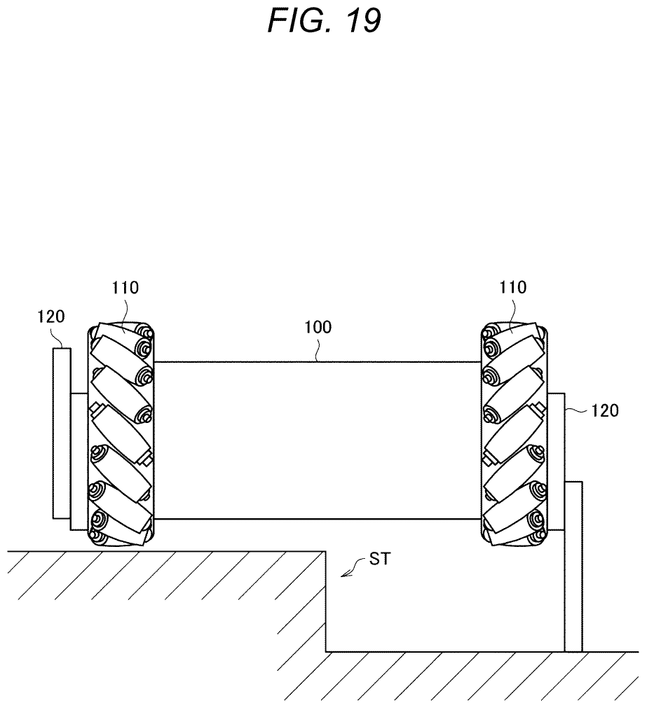

FIG. 18 is an explanatory view for explaining control of the leg part 120 according to the seventh modification. As illustrated in FIG. 18, the mobile body 10 can control the rotation angle of the omnidirectional wheel 110 by jumping by using the leg part 120 at the time of wheel traveling by the omnidirectional wheels 110.

For example, a case where the mobile body 10 that performs wheel traveling by the omnidirectional wheels 110 confirms the step ST ahead is considered (the state of (1) in FIG. 18). In such a case, the mobile body 10 can climb the step ST by hooking the leg part 120 on the upper surface of the step ST by using the control according to the sixth modification described above. However, a range of the rotation angle of the omnidirectional wheel 110 in which the leg part 120 protruding from the diameter of the omnidirectional wheel 110 can be hooked on the upper surface of the step ST is limited. Therefore, depending on the distance between the mobile body 10 and the step ST, there is a case where the mobile body 10 causes the omnidirectional wheel 110 to idle in front of the step ST in order to set the rotation angle of the omnidirectional wheel 110 to an appropriate rotation angle.

In the seventh modification, the mobile body 10 can jump by causing the leg part 120 to protrude from the diameter of the omnidirectional wheel 110 at a timing when the leg part 120 can come into contact with the ground at the time of wheel traveling by the omnidirectional wheel 110. Moreover, the mobile body 10 can adjust the rotation angles of the omnidirectional wheel 110 and the leg part 120 by rotating the omnidirectional wheel 110 in the air during the jump.

For example, in the state of (2) in FIG. 18, the mobile body 10 can make the two front wheels jump by making the leg parts 120 of the two front wheels in the traveling direction of the mobile body 10 protrude from the diameter of the omnidirectional wheels 110 (the state of (3) in FIG. 18). At this time, the mobile body 10 can rotate the omnidirectional wheels 110 and the leg parts 120 of the two front wheels during the jump (the state of (4) in FIG. 18). With this arrangement, upon reaching the step ST, the mobile body 10 can adjust the rotation angles of the omnidirectional wheels 110 and the leg parts 120 to enable the leg parts 120 to be hooked on the upper surface of the step ST (the state of (5) in FIG. 18).

Note that the angle at which the omnidirectional wheels 110 and the leg parts 120 of the two front wheels are rotated during the jump can be derived from, for example, the distance to the step ST measured by the mobile body 10, the height of the step ST, the moving speed of the mobile body 10, the diameter of the omnidirectional wheel 110, and the like. Furthermore, the mobile body 10 may adjust the rotation angles of the omnidirectional wheels 110 and the leg parts 120 little by little by performing the jump a plurality of times.

With this arrangement, the mobile body 10 can more efficiently climb the step ST at the time of wheel traveling by the omnidirectional wheels 110 by adjusting the rotation angles of the omnidirectional wheels 110 and the leg parts 120 during the jump.

### Eighth Modification

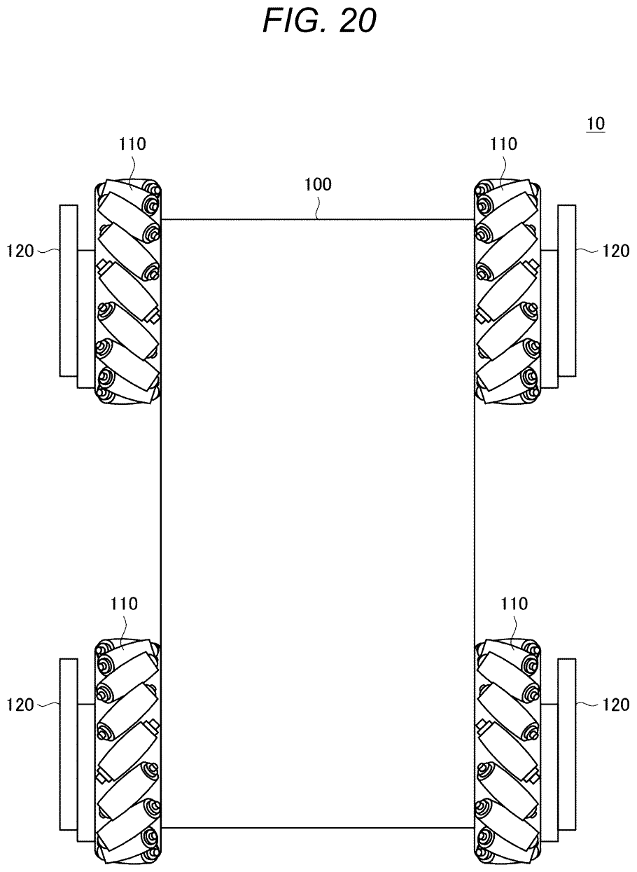

FIG. 19 is an explanatory view for explaining control of the leg part 120 according to the eighth modification. As illustrated in FIG. 19, the mobile body 10 can travel while performing wheel traveling by the omnidirectional wheels 110 and leg walking by the leg parts 120 in a mixed manner.

For example, in a case where two wheels on one side of the mobile body 10 are traveling on the upper surface of the step ST and two wheels on the other side are traveling on the lower surface of the step ST, the mobile body 10 may travel by wheel traveling on the upper surface of the step ST by the omnidirectional wheels 110, and meanwhile, may travel by leg walking on the lower surface of the step ST with the leg parts 120. Alternatively, the mobile body 10 may continuously jump on the lower surface of the step ST with the leg parts 120, and meanwhile, may travel by wheel traveling on the upper surface of the step ST by the omnidirectional wheels 110.

Moreover, the mobile body 10 may perform leg walking by the leg parts 120 on two front wheels in the traveling direction, and may also perform wheel traveling by the omnidirectional wheels 110 on two rear wheels. The mobile body 10 may perform leg walking by the leg parts 120 on two rear wheels in the traveling direction, and may also perform wheel traveling by the omnidirectional wheels 110 on two front wheels.

### 3. Supplementary Note

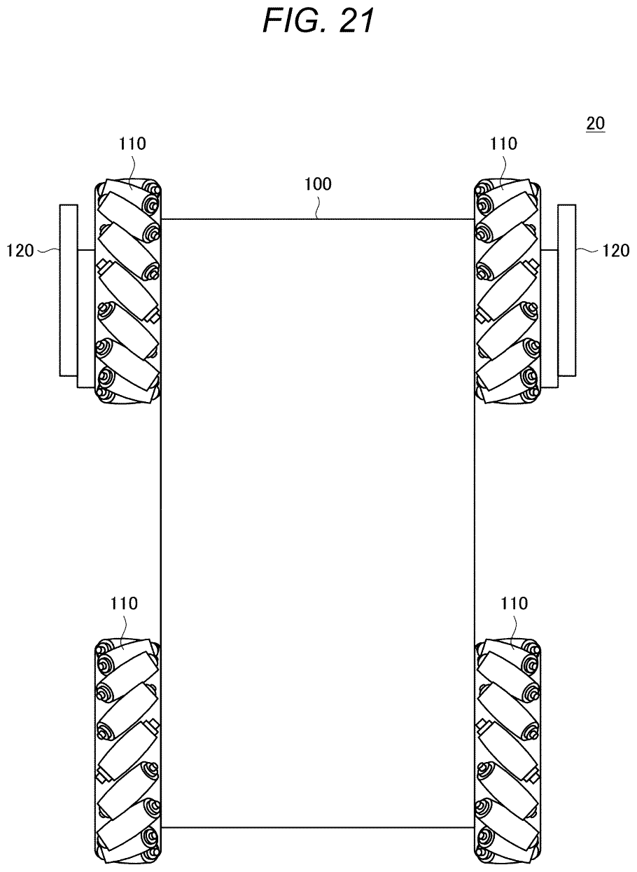

The mobile body 10 according to the present embodiment has been described in detail above. However, in the mobile body 10 according to the present embodiment, the omnidirectional wheels 110 and the leg parts 120 may be provided in all of the four wheels, or the omnidirectional wheels 110 and the leg parts 120 may be provided in a part of the four wheels. Such a point will be described with reference to FIGS. 20 to 22.

FIG. 20 is a schematic plan view illustrating a schematic structure of the mobile body 10 including the omnidirectional wheels 110 and the leg parts 120 in all of the four wheels. As illustrated in FIG. 20, the mobile body 10 according to the present embodiment may include the omnidirectional wheels 110 and the leg parts 120 in all of the four wheels. The omnidirectional wheel 110 is, for example, a mecanum wheel, and the leg part 120 is a four-node link. In such a case, the mobile body 10 can perform omnidirectional wheel traveling using all of the four wheels of the omnidirectional wheels 110 and perform leg walking using all of the four leg parts 120.

FIG. 21 is a schematic plan view illustrating a schematic structure of a mobile body 20 including the omnidirectional wheels 110 in all of the four wheels and the leg parts 120 in only two front wheels. As illustrated in FIG. 21, the mobile body 20 according to the present embodiment may include the omnidirectional wheels 110 in all of the four wheels and the leg parts 120 in only two front wheels. The omnidirectional wheel 110 is, for example, a mecanum wheel, and the leg part 120 is a four-node link. In such a case, the mobile body 20 can perform omnidirectional wheel traveling using all of the four wheels of the omnidirectional wheels 110. Furthermore, the mobile body 20 can perform an auxiliary motion of climbing a step with the leg parts 120 of the two front wheels at the time of wheel traveling.

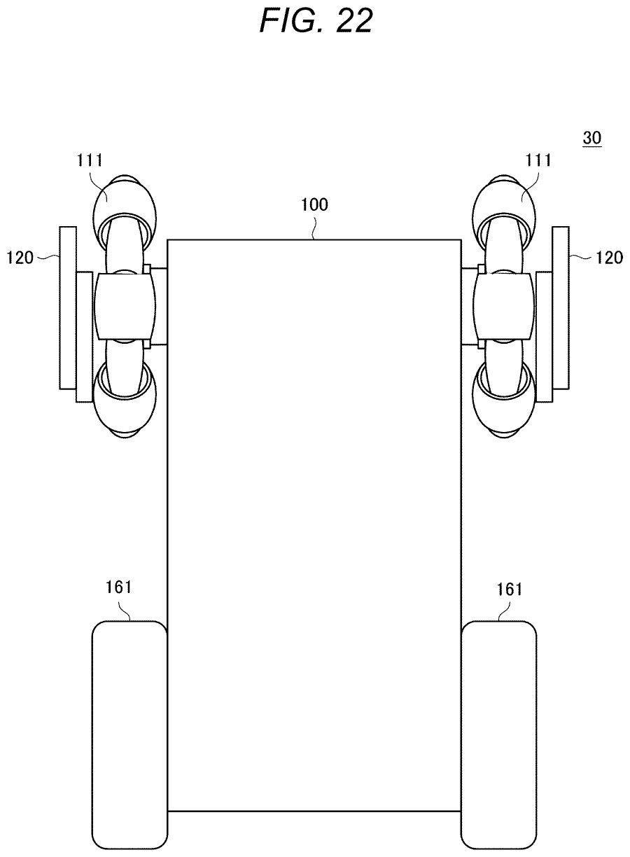

FIG. 22 is a schematic plan view illustrating a schematic structure of a mobile body 30 including the omnidirectional wheels 111 and the leg parts 120 in two front wheels. As illustrated in FIG. 22, the mobile body 30 according to the present embodiment may include the omnidirectional wheels 111 and the leg parts 120 in only two front wheels and normal wheels 161 in two rear wheels. The omnidirectional wheel 111 is, for example, an omni wheel, the leg part 120 is a four-node link, and the normal wheel 161 is a normal wheel driven by a motor. In such a case, by controlling the rotation speed and the rotation direction of the omnidirectional wheels 111 of the two front wheels and the normal wheels 161 of the two rear wheels, the mobile body 30 can turn more smoothly than a mobile body including only the normal wheels 161. Furthermore, the mobile body 30 can perform an auxiliary motion of climbing a step with the leg parts 120 of the two front wheels at the time of wheel traveling.

While the preferred embodiment of the present disclosure has been described in detail with reference to the accompanying drawings, the technical scope of the present disclosure is not limited to such examples. It is obvious that those with ordinary skill in the technical field of the present disclosure can conceive various alterations or corrections within the scope of the technical idea recited in the claims, and it is naturally understood that those alterations or corrections also fall within the technical scope of the present disclosure.

Because the mobile body to which the technology according to the present disclosure is applied can perform various motions, it is assumed that the mobile body is suitable for applications in the EdTech (Education +Technology) field, the entertainment field, or the research and development field. Furthermore, the mobile body to which the technology according to the present disclosure is applied can also be used for a transportation purpose of transporting an article, a medical or nursing care purpose of transporting a person, a following purpose of following the movement of a person, an environmental map creation purpose, an inspection purpose of checking or investigating the environment, or the like.

Furthermore, the effects described in the present description are merely exemplary or illustrative, and are not restrictive. In other words, the technology according to the present disclosure may exhibit other effects apparent to those skilled in the art from the description of the present description, in addition to the effects described above or instead of the effects described above.

Note that the following configurations also fall within the technological scope of the present disclosure.
(1)

A mobile body including:
a main body part;
at least two or more omnidirectional wheels attached to the main body part and rotated by driving of a motor; and
a leg part that extends, contracts, and revolves on the basis of a rotation angle change of a first shaft interlocking with rotation of each of the omnidirectional wheels and a rotation angle change of a second shaft coaxial with the first shaft.
(2)

The mobile body according to (1) described above, in which the omnidirectional wheel is a mecanum wheel.
(3)

The mobile body according to (1) described above, in which the omnidirectional wheel is an omni wheel.
(4)

The mobile body according to (3) described above, in which the omni wheel is attached to the main body part in an inclined manner at an angle of more than 0 degrees and less than 45 degrees with respect to a traveling direction of the mobile body.
(5)

The mobile body according to (4) described above, in which the leg part is attached to the omni wheel while interposing a universal joint between the leg part and the omni wheel, and is provided in parallel to the traveling direction.
(6)

The mobile body according to (4) described above, in which the leg part is formed elastically deformable in a direction orthogonal to the traveling direction, and provided in an inclined manner with respect to the traveling direction.
(7)

The mobile body according to any one of (1) to (6) described above, in which the leg part includes a link mechanism that has the first shaft and the second shaft as drive shafts, and extends and contracts by a rotation angle difference between the first shaft and the second shaft.
(8)

The mobile body according to (7) described above, in which the link mechanism includes a link on a tip end side of the leg part, the link having a shape that is curved toward an inner side of a closed loop of the link mechanism.
(9)

The mobile body according to (7) described above, in which the link mechanism includes links, each of the links being connected to another links on the same side on both ends of the link.
(10)

The mobile body according to (7) described above, in which the link mechanism includes a pantograph mechanism.
(11)

The mobile body according to any one of (1) to (10) described above, in which the omnidirectional wheel is included in at least two front wheels or two rear wheels of the mobile body in a traveling direction.
(12)

The mobile body according to (11) described above, in which the leg part is connected at least to each of the omnidirectional wheels of the two front wheels or each of the omnidirectional wheels of the two rear wheels.
(13)

The mobile body according to any one of (1) to (12) described above, in which the leg part is provided movably at a time when the omnidirectional wheel is rotating.
(14)

The mobile body according to any one of (1) to (13) described above, in which
the main body part is attached with four pieces of the omnidirectional wheels, and
the leg part is connected to each of the four pieces of the omnidirectional wheels.
(15)

The mobile body according to (14) described above, in which the four pieces of the omnidirectional wheels and four pieces of the leg parts are controlled independently of each other.
(16)

The mobile body according to any one of (1) to (15) described above, in which the leg part is extended to protrude from a diameter of the omnidirectional wheel at a time of wheel traveling by the omnidirectional wheel.
(17)

The mobile body according to (16) described above, in which the leg part protruding from the diameter of the omnidirectional wheel is used for step climbing.
(18)

The mobile body according to (16) described above, in which
the leg part protruding from the diameter of the omnidirectional wheel is used for a jump motion, and
at a time of the jump motion, the leg part that is not grounded has a revolving angle controlled.
(19)

The mobile body according to (16) described above, in which
the leg part protruding from the diameter of the omnidirectional wheel is used for a jump motion, and
at a time of the jump motion, the omnidirectional wheel that is grounded performs wheel traveling.

### REFERENCE SIGNS LIST

10, 11, 12, 20, 30 Mobile body
100 Main body part
110, 111 Omnidirectional wheel
115 Caster
117 Spring member
120 Leg part
130 Transmission mechanism
141 First motor
142 Second motor
151 Universal joint
152 Exterior part

1. A mobile body comprising:
a main body part;
at least two or more omnidirectional wheels attached to the main body part and rotated by driving of a motor; and
a leg part that extends, contracts, and revolves on a basis of a rotation angle change of a first shaft interlocking with rotation of each of the omnidirectional wheels and a rotation angle change of a second shaft coaxial with the first shaft.

2. The mobile body according to claim 1, wherein the omnidirectional wheel is a mecanum wheel.

3. The mobile body according to claim 1, wherein the omnidirectional wheel is an omni wheel.

4. The mobile body according to claim 3, wherein the omni wheel is attached to the main body part in an inclined manner at an angle of more than 0 degrees and less than 45 degrees with respect to a traveling direction of the mobile body.

5. The mobile body according to claim 4, wherein the leg part is attached to the omni wheel while interposing a universal joint between the leg part and the omni wheel, and is provided in parallel to the traveling direction.

6. The mobile body according to claim 4, wherein the leg part is formed elastically deformable in a direction orthogonal to the traveling direction, and provided in an inclined manner with respect to the traveling direction.

7. The mobile body according to claim 1, wherein the leg part includes a link mechanism that has the first shaft and the second shaft as drive shafts, and extends and contracts by a rotation angle difference between the first shaft and the second shaft.

8. The mobile body according to claim 7, wherein the link mechanism includes a link on a tip end side of the leg part, the link having a shape that is curved toward an inner side of a closed loop of the link mechanism.

9. The mobile body according to claim 7, wherein the link mechanism includes links, each of the links being connected to another links on a same side on both ends of the link.

10. The mobile body according to claim 7, wherein the link mechanism includes a pantograph mechanism.

11. The mobile body according to claim 1, wherein the omnidirectional wheel is included in at least two front wheels or two rear wheels of the mobile body in a traveling direction.

12. The mobile body according to claim 11, wherein the leg part is connected at least to each of the omnidirectional wheels of the two front wheels or each of the omnidirectional wheels of the two rear wheels.

13. The mobile body according to claim 1, wherein the leg part is provided movably at a time when the omnidirectional wheel is rotating.

14. The mobile body according to claim 1, wherein
the main body part is attached with four pieces of the omnidirectional wheels, and
the leg part is connected to each of the four pieces of the omnidirectional wheels.

15. The mobile body according to claim 14, wherein the four pieces of the omnidirectional wheels and four pieces of the leg parts are controlled independently of each other.

16. The mobile body according to claim 1, wherein the leg part is extended to protrude from a diameter of the omnidirectional wheel at a time of wheel traveling by the omnidirectional wheel.

17. The mobile body according to claim 16, wherein the leg part protruding from the diameter of the omnidirectional wheel is used for step climbing.

18. The mobile body according to claim 16, wherein
the leg part protruding from the diameter of the omnidirectional wheel is used for a jump motion, and
at a time of the jump motion, the leg part that is not grounded has a revolving angle controlled.

19. The mobile body according to claim 16, wherein
the leg part protruding from the diameter of the omnidirectional wheel is used for a jump motion, and
at a time of the jump motion, the omnidirectional wheel that is grounded performs wheel traveling.
